(19) United States
(12) Patent Application Publication
(10) Pub. No.: US 2026/0067574 A1
(43) Pub. Date: Mar. 5, 2026

(54) IMAGING DEVICE AND CONTROLLING METHOD THEREOF

(71) Applicant: MEDIATEK INC., Hsinchu City (TW)

(72) Inventors: Chi-Cheng JU, Hsinchu City (TW); Yu-Chang HUANG, Hsinchu City (TW); Yan-Shao LIU, Hsinchu City (TW); Kai WEI, Hsinchu City (TW); Sheng-Jie LI, Hsinchu City (TW)

(21) Appl. No.: 19/304,941

(22) Filed: Aug. 20, 2025

Related U.S. Application Data
(60) Provisional application No. 63/687,359, filed on Aug. 27, 2024.

(51) Int. Cl. H04N 23/69; H04N 23/45; H04N 23/73; H04N 23/74; H04N 23/745

(52) U.S. Cl. CPC H04N 23/69; H04N 23/45; H04N 23/73; H04N 23/74; H04N 23/745

(57) ABSTRACT

The present application provides an imaging device and controlling method thereof. The imaging device may include a plurality of imaging sensors. The plurality of imaging sensors may include a first imaging sensor and a second imaging sensor. The control method may include: determining, when the first imaging sensor is in operation, whether it is necessary to switch to the second imaging sensor; and instructing, in response to being necessary to switch to the second imaging sensor, the second imaging sensor to perform a sensor resume procedure. The instructing the second imaging sensor to perform the sensor resume procedure may include: reducing an initial shutter time of the second imaging sensor to reduce a sensor resume time of the second imaging sensor.

### CROSS-REFERENCE TO RELATED APPLICATION

This application is a continuation application of U.S. Provisional Patent Application No. 63/687,359 filed on Aug. 27, 2024, which is incorporated herein by reference in its entirety.

### TECHNICAL FIELD

The present disclosure relates to the technical field of imaging technologies, in particularly relates to an imaging device and a controlling method thereof.

### BACKGROUND

Imaging devices may be typically equipped with two or more imaging sensors (also referred to as camera sensors). Different imaging sensors may correspond to different zoom factors, which can meet various shooting scenarios and requirements. Before actual shooting, users can view the images captured by the sensors through a preview interface of the imaging device and adjust the zoom factor as needed. The preview interface may generally be a screen of the imaging device.

During the zoom operation on the preview interface, users may expect the displayed content to change with different zoom levels, while the screen center or the overall brightness remain unchanged.

Since a single imaging sensor cannot achieve the desired zoom rang, an underlying system of the imaging device may automatically switch between different imaging sensors based on the zoom level. The switching speed of sensors (i.e., the speed at which the switched sensor starts to capture images) needs to be as fast as possible.

### SUMMARY

According to a first aspect of the present disclosure, a method for controlling an imaging device may be provided. The imaging device may include a plurality of imaging sensors. The plurality of imaging sensors may include a first imaging sensor and a second imaging sensor. The control method may include: determining, when the first imaging sensor is in operation, whether it is necessary to switch to the second imaging sensor; and instructing, in response to being necessary to switch to the second imaging sensor, the second imaging sensor to perform a sensor resume procedure. The instructing the second imaging sensor to perform the sensor resume procedure may include: reducing an initial shutter time of the second imaging sensor to reduce a sensor resume time of the second imaging sensor.

According to a second aspect of the present disclosure, an imaging device may be provided. The imaging device may include a plurality of imaging sensors and an application processor. The plurality of imaging sensors may include a first imaging sensor and a second imaging sensor. The application processor may store executable code. The application processor may be configured to execute the executable code to perform a method for controlling the imaging device. The method may include: determining, when the first imaging sensor is in operation, whether it is necessary to switch to the second imaging sensor; and instructing, in response to being necessary to switch to the second imaging sensor, the second imaging sensor to perform a sensor resume procedure. The instructing the second imaging sensor to perform the sensor resume procedure may include: reducing an initial shutter time of the second imaging sensor to reduce a sensor resume time of the second imaging sensor.

### BRIEF DESCRIPTION OF THE DRAWINGS

In order to more clearly illustrate technical solutions in the present disclosure, the drawings required in the description of the embodiments will be briefly introduced below. Obviously, the drawings in the following description are only some embodiments of the present disclosure. For those of ordinary skills in the art, other drawings could be obtained based on these drawings without creative efforts and should fall within the scope of the present disclosure. Among the drawings:

FIG. 1 is a schematic front view of an imaging device according to some embodiments of the present disclosure.

FIG. 2 is a schematic rear view of the imaging device as illustrated in FIG. 1.

FIG. 3 is a schematic diagram of zoom factor ranges of a plurality of imaging sensors of the imaging device as illustrated in FIG. 1.

FIG. 4 is a timing diagram of switching from the first imaging sensor to the second imaging sensor in related art.

FIG. 5 is a schematic flowchart of a method for controlling the imaging device according to some embodiments of the present disclosure.

FIG. 6 is a schematic flowchart of an imaging sensor switching method for an imaging device according to some embodiments of the present disclosure.

FIG. 7 is a schematic flowchart of software control during the sensor switching process according to some embodiments of the present disclosure.

FIG. 8 is a schematic flow diagram for determining the shutter time of the second imaging sensor in the sensor resume procedure according to some embodiments of the present disclosure.

FIG. 9 is a schematic timing diagram of a procedure where a user switches the imaging sensors through dynamic adjustment according to some embodiments of the present disclosure.

FIG. 10 is a schematic timing diagram of a procedure where a user switches the imaging sensors through direct designation according to some embodiments of the present disclosure.

FIG. 11 is a schematic timing diagram of a procedure where a user switches the imaging sensors through direct designation according to some other embodiments of the present disclosure.

FIG. 12 is a schematic structural diagram of an imaging device according to some embodiments of the present disclosure.

### DETAILED DESCRIPTION

Technical solutions in embodiments of the present disclosure will be described clearly and thoroughly in connection with accompanying drawings of the embodiments of the present disclosure in the following. It should be appreciated that, the specific embodiments described herein are for the purpose of explaining the present application only and but not for limiting it. It should also be noted that, for case of description, the accompanying drawings show only part, but not all, of the structures relevant to the present disclosure. All other embodiments by a person of ordinary skills in the art based on embodiments of the present disclosure without creative efforts should all be within the protection scope of the present disclosure.

The terms “first” and “second” and the like in the present disclosure are used for distinguishing between different items and not for describing a particular sequence. In addition, the terms “include”, “comprise” and any variations thereof are intended to cover non-exclusive inclusion. For example, a process, a method, a system, a product, or a device that includes a series of operations or units is not limited to the listed operations or units, but optionally includes unlisted operations or units, or optionally also includes other operations or units inherent to these processes, methods, products or devices.

Reference to “embodiments” herein means that a specific feature, structure, or characteristic described in conjunction with the embodiments may be included in at least one embodiment of the present disclosure. The appearance of this phrase in various locations in the specification does not necessarily refer to the same embodiment, nor is it an independent or alternative embodiment mutually exclusive with other embodiments. Those skilled in the art may explicitly and implicitly understand that, the embodiments described herein may be combined with other embodiments.

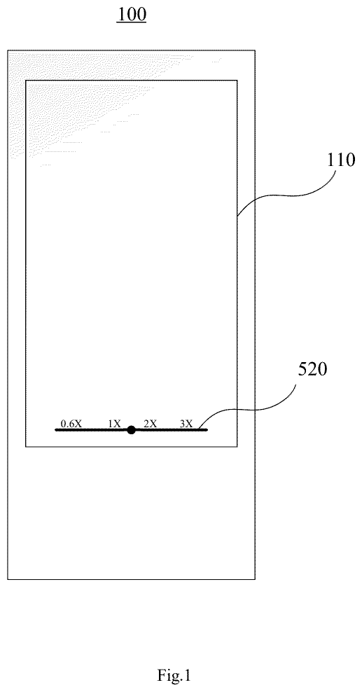

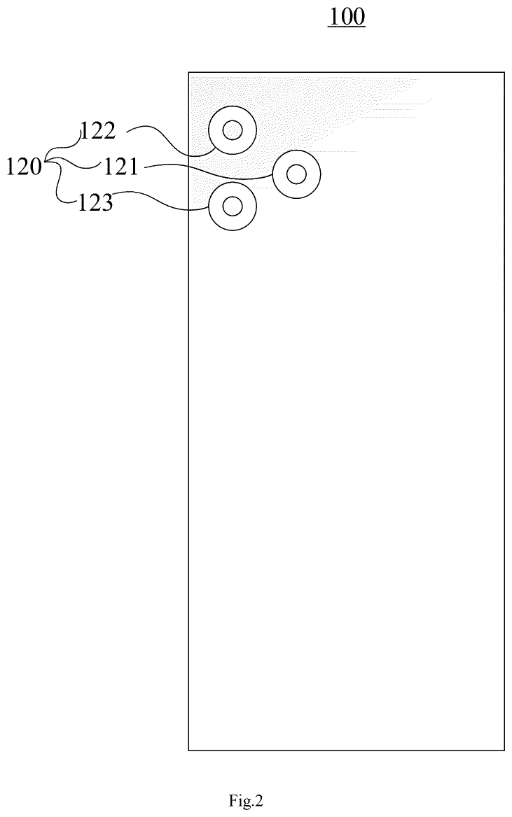

As illustrated in FIG. 1 and FIG. 2, FIG. 1 illustrates a front view of an imaging device 100 according to some embodiments of the present disclosure, and FIG. 2 illustrates a rear view of the imaging device 100 of FIG. 1. As illustrated in FIG. 1, the imaging device 100 may include a view finder 110. As illustrated in FIG. 2, the imaging device 100 may include a plurality of imaging sensors 120. Different imaging sensors 120 may cover different focal length ranges.

The imaging device 100 may be, for example, a mobile phone, a smart phone, a tablet computer, a digital camera, or other such devices, which is not limited herein. An imaging sensor 120 may also be referred to as a camera sensor. The imaging sensor 120 may be, for example, a CMOS (complementary metal-oxide-semiconductor) sensor, a charge coupled device (CCD), or the like.

As illustrated in FIG. 2, the plurality of imaging sensors 120 equipped in the imaging device 100 may include an ultra-wide sensor 121, a primary sensor 122 (also referred to as a main eye), a telephoto sensor 123, or the like. The ultra-wide sensor 121 may be abbreviated as Ultra Wide in the drawings, the telephoto sensor may be abbreviated as Tele in the drawings. The focal length range of the primary sensor 122 may generally range from 24 mm to 50 mm, which may be close to the viewing angle range of a human eye and may meet most daily image shooting needs. In some embodiments, the primary sensor 122 may be a wide-angle sensor or wide sensor. The wide sensor may be abbreviated as Wide in the drawings. A focal length of the ultra-wide sensor 121 may usually range from 14 mm to 35 mm, which may capture a wider scene. The telephoto sensor may have a greater focal length, which may be greater than 70 mm, so as to shoot distant objects. In some embodiments, the plurality of imaging sensors may also include a macro imaging sensor. The focal length of the macro imaging sensor may for example be as less as 10 mm, for example, to better meet requirements of close-up photography. The imaging device 100 may also include only two imaging sensors, or more than three imaging sensors, which is not limited herein.

Before describing the technical schemes of the present disclosure in detail, for convenience of understanding, the following several concepts may be briefed first.

### General Structure of the Imaging Device 100 and its Camera

In some embodiments, taking a smartphone as an example of the imaging device, a camera may include a lens group and an imaging sensor. One camera may, for example, include one imaging sensor. The lens group may consist of plurality of lenses to collect external light and focus the light on a surface of the imaging sensor. The imaging sensor, such as the aforementioned CMOS or CCD sensor, may convert the received optical signals into electrical signals.

In some embodiments, the camera may further include a focusing motor. The focusing motor may be configured to drive the lens group of the camera to move back and forth, so as to adjust the focal length of the camera, thereby achieving auto-focus (AF).

In some embodiments, the imaging device 100 may also include an application processor (AP). The application processor may be configured to activate the camera.

In some embodiments, the imaging device 100 may include one or more image signal processors (ISPs). For example, there is a one-to-one correspondence between the image signal processors and the cameras, or a single image signal processor may be configured to process electrical signals from one or more cameras. The image signal processor may, under scheduling of the application processor, wake up the corresponding camera, perform auto-focus operations for the corresponding camera, process electrical signals from the camera, and/or return the processed image data to the application processor.

In some embodiments, the image signal processor may be also responsible for operations such as digital zoom and/or crop zoom described below.

In some embodiments, the imaging device 100 may further include a cache and/or a view finder 110. The image processor may process the electrical signals from the imaging sensor of the camera to form preview frames. The preview frames may be transmitted from the image sensor to the cache through the application processor, for the view finder 110 to read out and display. In cases where the imaging device 100 is not equipped with an image signal processor, the application processor itself may process the electrical signals from the imaging sensor of the camera to generate preview frames, which may then be transmitted to the cache for the view finder 110 to read out and display.

In some embodiments, the preview frames may be dynamically refreshed, for example, 30 frames per second, 60 frames per second, etc.

### Physical Focal Length

The “focal length” may be generally measured in millimeters (mm), and may refer to a distance from the point where light converges inside the camera to the imaging sensor when the focus is at its sharpest. In general, the longer the focal length, the smaller a visible scene range of the camera, and the narrower the viewing angle. Conversely, the shorter the focal length, the wider the viewing angle.

### 35 mm Equivalent Focal Length

In scenarios where the imaging device 100 is a smart phone, a tablet, or the like, the internal space is very valuable, the camera is very small and have tiny sensor. The “focal length” of the camera may generally refer to an equivalent value of a 35 mm format sensor, i.e., the 35 mm equivalent focal length, which may be briefed as an equivalent focal length.

The 35 mm equivalent focal length of the camera may refer to, the focal length of the lens that would be needed on a camera equipped with a 35 mm full-frame sensor, so as to obtain the same shooting view angle and image as the current camera with its specific physical focal length.

The 35 mm focal length equivalent of a lens gives you an idea of the focal length of the camera you′d need to use if you were to capture the same image using a camera with a 35 mm full-format sensor. The actual distance between where the image is focused inside the camera to where it's captured on the sensor is very short. For example, a smartphone camera marketed as having a 26 mm lens may actually for example have a focal length of 4.25 mm.

### Focal Length and View Angle

The view angle may refer to a range of a scene that can be seen through a camera, and may be generally measured in degrees. As mentioned above, the focal length is closely related to the “view angle”. The shorter the focal length of a camera, the wider the view angle, and the more of the scene that can be captured. The longer the focal length, the narrower the view angle, and the more pronounced a magnification effect of the subject being photographed.

### EQUIVALENT VIEW ANGLE MAGNIFICATION

On a preview interface 110 of the imaging device 100, as illustrated in FIG. 1, the focal length may often be expressed in the format of a number followed by the letter “X”, such as 1×, 2×, 1.6×, etc. The number in this format may represent the equivalent view angle magnification. The equivalent view angle magnification may also be referred to as a zoom factor, magnification identifier, or zoom value. 1× may correspond to a reference equivalent focal length of a camera (usually the primary camera), such as a focal length of 35 mm. NX may indicate that the view angle is switched to 1/N of the 1× state, and the equivalent focal length is switched to N times that of the 1× state. In other words, NX may indicate that the view angle is magnified to N times the original view angle, where N is a real number.

The “X” on the preview interface 110 is a “user-friendly expression” of the focal length. Magnifications other than 1× are the results of view angle scaling after the focal length is scaled proportionally based on a reference focal length. The “X” expression not only reflects the optical characteristics of the focal length but also facilitate the user to quickly understand the scaling degree of the shooting range.

In the present disclosure, the focal length may be expressed in the form of focal length (physical focal length or equivalent focal length) or equivalent view angle magnification (also referred to as zoom factor).

### Approaches for Switching Focal Lengths

In some embodiments, users may select a desired target focal length through dynamic adjustment switching, direct designation, or other approaches to achieve focal length switching.

As illustrated in FIG. 1, there is a preview interface 110 (also referred to as a view finder 110) or preview screen provided for the imaging device 100. When the camera function is activated, the screen may display a preview image.

### Dynamic Adjustment Switching or Dynamic Adjustment Zoom

In some embodiments, the user may select the desired target focal length by dynamically adjusting the zoom factor. Dynamic adjustment approaches may include gesture operations on the preview interface 110, continuous operation of buttons on the imaging device 100, etc. In the case of gesture operations, the user may gradually switch the zoom factor through approaches such as sliding a zoom bar with fingers, multi-finger pinching and spreading, or the like. As illustrated in FIG. 1, the preview interface 110 may be provided with a virtual sliding bar 520 for the end user to slide. In the case of continuous operation of buttons on the imaging device 100, the user may gradually switch the zoom factor by long-pressing a zoom button of the imaging device 100, or the like. The buttons may be, for example, physical buttons or virtual buttons of the imaging device 100. Virtual buttons may for example be presented on the preview interface 110 of the imaging device 100.

Through dynamic adjustment switching, the user may realize real-time and gradual changes in the zoom factor. During the switching process, the user may intuitively observe the zoom effect of the screen, obtain timely feedback, and dynamically select the target focal length to switch to.

### Direct Designation Switching or Direct Designation Zoom

In some embodiments, the user may select the desired target focal length by directly specifying the zoom factor. Optionally, the user may directly input specific target zoom factor or target focal lengths. Optionally, the user may select target zoom factors or target focal lengths from a preset candidate list. The preset candidate list may be presented, for example, on the preview interface 110, and the user may select specific target zoom factors by clicking on a required candidate. The preset candidate list may also be implemented as physical buttons on the imaging device 100, which is not limited herein. Direct designation is generally applicable to scenarios where the user has clear requirements or a clear understanding of zoom accuracy. This approach may have efficient operation and good controllability of results.

### Physical Zoom

In some embodiments, the camera may adjust the focal length by moving the lens group back and forth, thereby physically changing the focal length or the zoom factor. This approach of changing the focal length may be referred to as physical zoom, optical zoom, or physical scaling.

However, in imaging devices 100 such as mobile phones, the range of physical zoom factor may be limited due to volume constraints. Some imaging devices 100 even do not have the capability of physical zoom at all.

### Digital Zoom/Crop Zoom

The digital zoom, also referred to as the crop zoom, is an approach that achieves an equivalent “zoom” effect through digital processing of images. The digital zoom process does not actually change the focal length of the camera. The principle of digital zoom is to crop a partial area from the original image obtained by the imaging sensor and enlarge the same for display on the preview interface.

In general, a resolution of the image captured by the camera of the imaging device 100 is higher than that of the display screen.

Taking the digital zoom factor range of 1×-1.6× corresponding to the primary camera of the imaging device 100 as an example. The resolution of the original image obtained by the primary camera may be, for instance, 50 million pixels, while the display pixels of the preview interface 110 of the imaging device 100 may be, for example, 2.61 million pixels. Within this digital zoom factor range, a sufficiently clear preview image may be obtained by enlarging and displaying a portion of the original image.

The digital zoom process may often, by means of interpolation algorithms or other approaches, supplement missing pixel information after the original image is enlarged, so as to allow the preview image visually present a close-up or zoom in effect. Since the missing pixel information is supplemented by interpolation etc., when the zoom factor of the crop zoom process is too large, the preview image may become blurred.

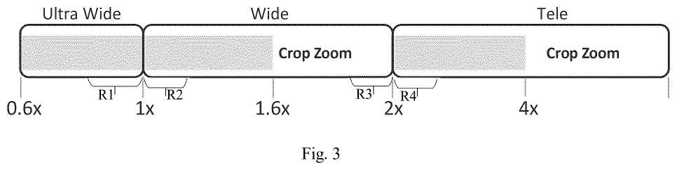

As illustrated in FIG. 3, FIG. 3 illustrates a schematic diagram of the zoom factor range of the plurality of imaging sensors 120 of an imaging device 100 according to some embodiments of the present disclosure.

The imaging device 100 may include a first imaging sensor and a second imaging sensor. The first imaging sensor may include a first zoom factor range. The second imaging sensor may include a second zoom factor range different from the first zoom factor range. As illustrated in FIG. 3, the imaging device 100 may include at least three imaging sensors: an ultra-wide sensor, a wide-angle sensor, and a telephoto sensor. The ultra-wide sensor may include a zoom factor range of, for example, 0.6× to 1×. The wide sensor may include a zoom factor range of, for example, 1× to 2×. The telephoto sensor may include a zoom factor range of, for example, greater than 2×. The first imaging sensor mentioned above may be one of the three imaging sensors: the ultra-wide sensor, the wide sensor, and the telephoto sensor. The second imaging sensor may be another one of these three imaging sensors.

In some embodiments, the zoom factor range of at least one imaging sensor of the imaging device 100 may include a sensor switching interval. The sensor switching interval may be a preset interval in the zoom factor range of one imaging sensor that is adjacent to the zoom factor range of another imaging sensor. As illustrated in FIG. 3, the ultra-wide sensor may include a first sensor switching interval R1 adjacent to the zoom factor range of the wide sensor. The wide sensor may include a second sensor switching interval R2 adjacent to the ultra-wide sensor and a third sensor switching interval R3 adjacent to the telephoto sensor. The telephoto sensor may include a fourth sensor switching interval R4 adjacent to the wide sensor.

By way of example and not limitation, the imaging sensor may perform crop zoom over its entire zoom factor range, or the imaging sensor may perform crop zoom within a portion of its zoom factor range. For example, the wide sensor may perform crop zoom over a part of its zoom factor range, such as from 1.6× to 2×. The telephoto sensor may perform digital zoom over a part of its zoom factor range, such as greater than 4×.

In some embodiments, when a user performs a zoom operation, the imaging device 100 may capture this zoom operation and generate a corresponding request based on the user's operation, such as an application processor (AP) request. The user may perform the zoom operation through dynamic adjustment type or direct designation type as described above. For example, the user may click a zoom bar 520 in the preview interface 110 of the imaging device 100 to perform the zoom operation, which is not limited herein. In a direct designation type zoom operation, the AP request may include a specific zoom factor. In a dynamically adjustment zoom operation, the AP request may include the current specific zoom factor and a zoom direction. The zoom direction may indicate whether the user is currently zooming in or out.

In some embodiments, a hardware abstract layer (HAL layer) of the camera may receive the AP request. The HAL may determine whether the zoom factor has reached a threshold that requires activating another imaging sensor. The HAL layer may determine whether to activate the another imaging sensor through a built-in algorithm and a preset threshold range.

In some embodiments, when it is determined that the another sensor (also referred to as a target imaging sensor below) needs to be activated, the target imaging sensor may enter a sensor resume process. The sensor resume process may include: a software-set time, a sensor stream on time, and shutter time. The shutter time may also be referred to as an exposure time.

During the software-set time, a processor of the imaging device 100 may send parameters required for the sensor resume process to the target imaging sensor, and/or initialize hardware state of the target imaging sensor, etc. The software-set time may be generally related to an execution frequency of the processor and cannot be altered.

During the sensor stream on time, a hardware module of the target imaging sensor may be woken up, powered on, and enter an operation mode. The target imaging sensor may also establish a data connection with an image signal processor (ISP), confirm parameters, etc., to prepare for the subsequent shutter time. The sensor stream on time of the target imaging sensor may be generally fixedly set by the sensor manufacturer and also cannot be altered.

### Shutter Time

The term “shutter time” may also be referred as “exposure time”.

From a hardware implementation perspective, the shutters of the imaging sensors may be divided into mechanical shutters and electronic shutters. A mechanical shutter may control the time that light enters the imaging sensor through opening and closing of physical blades. An electronic shutter may control the light-sensing time of pixels through a circuit, such as turning on/off the photodiodes of pixels to receive light, without the need for mechanical structures.

From the perspective of implementation modes, the shutters of the imaging sensors may be divided into global shutters and rolling shutters. In a global shutter mode, all pixels of the imaging sensor may start exposure at a same time and end exposure at the same time. In some embodiments, after the exposure of the imaging sensor is completed, the charges of all pixels may be transferred to an independent storage area at one time, and then the image data is read out row by row. In the rolling shutter mode, the exposure and readout of pixels may be carried out “row by row”. After the exposure of one row of pixels ends, readout starts immediately, and at the same time, the next row starts exposure, the operation may proceed sequentially like a “rolling curtain”.

Either the mechanical shutter or the electronic shutter may be combined with either the global shutter mode or the rolling shutter mode to form four types of shutters: a mechanical global shutter, a mechanical rolling shutter, an electronic global shutter, and an electronic rolling shutter. In some embodiments, the shutter of the imaging sensor may also include a global reset shutter, or the like. In portable imaging devices such as mobile phones, the electronic rolling shutter is the most common form. The present disclosure does not limit the specific shutter mode of the imaging device.

When switching imaging sensors, the end user may expect that the center brightness or the overall brightness of the preview screen would not change.

In the related art, while switching imaging sensors, in order to avoid a phenomenon of image brightness change, a 3A offline synchronization technology may often be used. In this technology, the auto-exposure (AE) information of the first imaging sensor that is current previewed may be synchronized to the second imaging sensor that is about to be started. Although each imaging sensor has different sensitivity, the shutter time of the second imaging sensor may be roughly the same as that of the first imaging sensor at this time. The shutter time is generally relatively long, for example, about 10 to 30 milliseconds, which is often longer than the time of one frame. The longer shutter time may prolong the resume time of the second imaging sensor.

For the end user, during zoom operations, especially during the dynamic adjustment zoom operations, continuous pauses may occur when zooming out, resulting in a sense of stuttering. While the preview image may become blurred when zooming in.

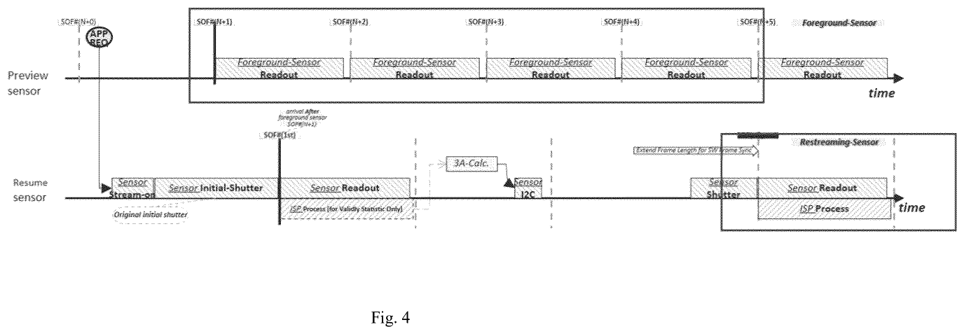

As illustrated in FIG. 4, FIG. 4 is a timing diagram of switching from the first imaging sensor to the second imaging sensor in related art. The current preview image may come from the first imaging sensor, also referred to as a preview sensor or a foreground sensor, and the sensor to be switched to may be referred to as the resume sensor. SOF may mean start of a frame. As illustrated in FIG. 4, the processor or the application program of the imaging device 100 may send a switching request, which may be illustrated as an AP request for an example. The second imaging sensor may collect an initial image after the sensor streaming on time and the shutter time. The initial image may be read out. The imaging device 100 may then recalculate the 3A parameters of the second imaging sensor based on the initial image. The processor of the imaging device 100 may transmit the updated 3A parameters to the second imaging sensor through the I2C (inter-integrated circuit) bus protocol. The second imaging sensor may perform a second image acquisition process based on the updated 3A parameters. The second frame image output by this second image acquisition process may be used for preview later.

In the related art, the shutter time during the sensor resume process may generally be greater than one frame, which leads to an excessively long time for sensor resume. As illustrated in FIG. 4, after the AP request or APP request of FIG. 4 configured to start the sensor switching process is issued, the preview sensor may continue to collect images, and the collected images may continue to be used for four frames. During this process, the zoom factor range of the preview sensor may not match the zoom factor expected by the user, and since the target imaging sensor cannot be switched to as soon as possible, the preview interface may be stuck or blurred.

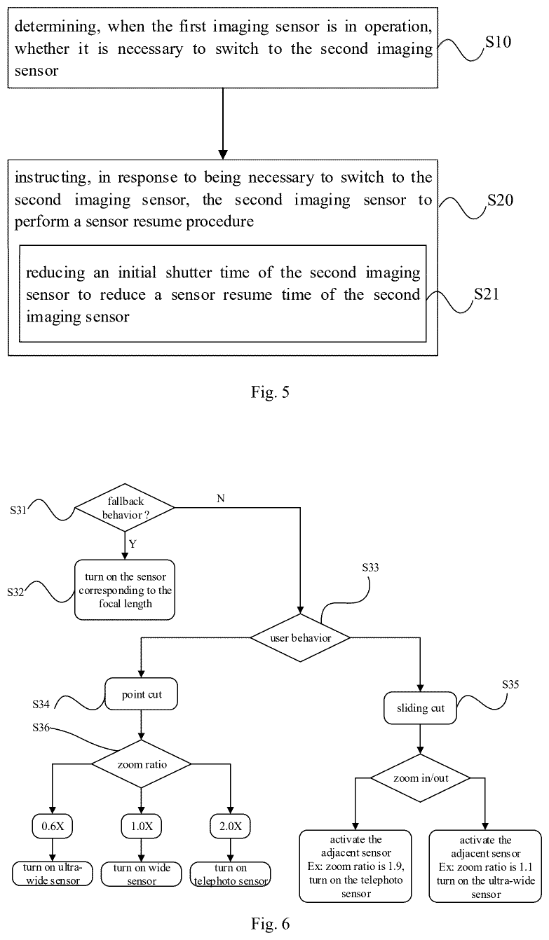

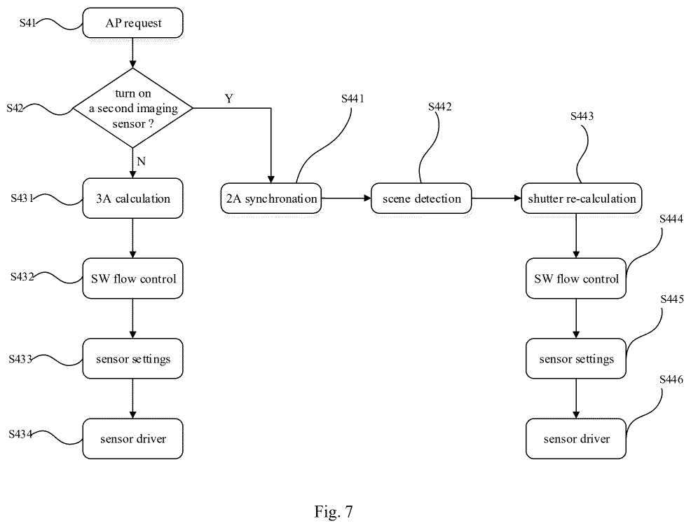

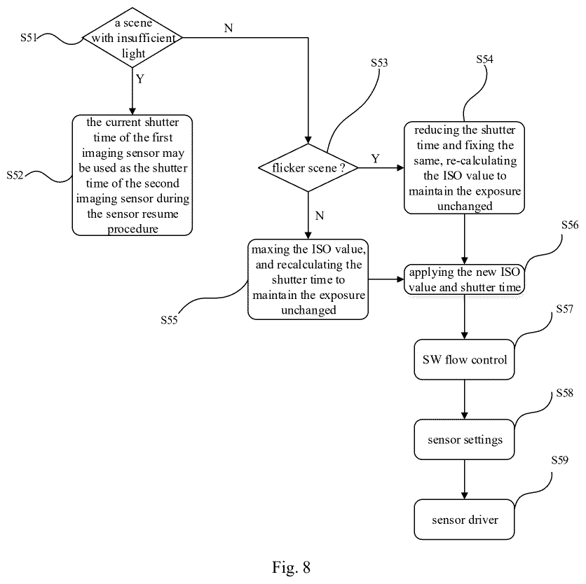

As illustrated in FIG. 5, FIG. 6, and FIG. 7, FIG. 5 is a schematic flowchart of a method for controlling the imaging device 100 according to some embodiments of the present disclosure, FIG. 6 is a schematic flowchart of an imaging sensor switching method for an imaging device 100 according to some embodiments of the present disclosure, and FIG. 7 is a schematic flowchart of software control during the sensor switching process according to some embodiments of the present disclosure.

In some embodiments, the imaging device 100 may include a plurality of imaging sensors 120. The plurality of imaging sensors 120 may include the first imaging sensor and the second imaging sensor. As described above with reference to FIG. 3, the first imaging sensor may include the first zoom factor range. The second imaging sensor may include the second zoom factor range different from the first zoom factor range. The first zoom factor range may include a sensor switching interval. The sensor switching interval may be a preset interval (such as the R1, R2, R3 or R4 in FIG. 3) in the first zoom factor range that is adjacent to the second zoom factor range.

As illustrated in FIG. 5, the control method may include the following operations at blocks of FIG. 5.

The operation at block S10: determining, when the first imaging sensor is in operation, whether it is necessary to switch to the second imaging sensor.

In some embodiments, as illustrated in FIG. 6, the operation at block S31: determining whether there is a fallback behavior. The fallback behavior may refer to that, in response to an auto focus operation determining that the distance between the imaging sensor and the to-be-shot subject is too small, the imaging device may directly activate a corresponding sensor, such as the ultra-wide sensor. If the fallback behavior exits, proceeding to the operation at block S32, where the second imaging sensor corresponding to the focal length of the auto-focus value is automatically turned on. For example, in a case where the imaging device 100 is very close to the shooting object, such that a macro imaging sensor is required, the macro imaging sensor corresponding to the focal length may be automatically turned on. If not, proceeding to the operation at block S33: determining the user behavior.

In some embodiments, in the case where the user performs a direct designation zoom operation (such as a point cut zoom operation at block S34 of FIG. 6, where the user clicks a specific point of the imaging device to select a zoom factor), determining, in response to the zoom factor selected by the user being within the second zoom factor range, that a switch to the second imaging sensor is required.

By way of example and not limitation, as illustrated at block S36 of FIG. 6, in the case where the user performs a direct designation zoom operation, receiving the zoom factor selected by the user. Based on the zoom factor selected by the user, determining which imaging sensor's zoom factor range the selected zoom factor falls into, and then identifying that imaging sensor as the one that needs to be turned on. By way of example and not limitation, as illustrated in FIG. 6, if the zoom factor is 0.6×, the zoom factor is within the zoom factor range of the ultra-wide sensor, the ultra-wide sensor may be turned on. If the zoom factor is 1.0×, the zoom factor is within the zoom factor range of the wide sensor, the wide sensor is turned on. If the zoom factor is 2.0×, the zoom factor is within the zoom factor range of the telephoto sensor, the telephoto sensor is turned on.

In some embodiments, in a case where the end user performs the dynamic adjustment zoom operation (such as a sliding cut zoom operation at block S35 of FIG. 6, where the user drags the sliding bar to change the zoom factor), in response to a zoom direction of the sliding cut zoom operation being from the first zoom factor range to the second zoom factor range and a current zoom factor being within the sensor switching interval, determining that it is necessary to switch to the second imaging sensor.

By way of example and not limitation, as illustrated at block S35 of FIG. 6, in the case where the end user performs a sliding cut zoom operation, determine the user's zoom direction. The zoom direction may be zooming in (making the picture closer, with the zoom factor increasing) or zooming out (making the picture farther, with the zoom factor decreasing). As illustrated in FIG. 6, taking the currently operating imaging sensor as a wide sensor as an example, if the end user performs a sliding cut zoom operation to increase the zoom factor, and the zoom factor enters the third sensor switching interval of the wide sensor as illustrated in FIG. 3, the telephoto sensor whose zoom factor range is adjacent to the third sensor switching interval may be activated. If the user performs a sliding cut zoom operation to decrease the zoom factor, and the zoom factor enters the second sensor switching interval of the wide sensor as illustrated in FIG. 3, the ultra-wide sensor whose zoom factor range is adjacent to the second sensor switching interval may be activated.

In some embodiments, as illustrated at block S41 of FIG. 7, before each frame is captured, the imaging device 100 may issue an application processor request (AP request). The AP request may include information such as whether it is necessary to switch the imaging sensor and the second imaging sensor to be switched to (if existed), or the like. The AP request may also include information such as the zoom factor and the current 3A parameters.

The operation at block S20: instructing, in response to being necessary to switch to the second imaging sensor, the second imaging sensor to perform a sensor resume procedure.

The instructing the second imaging sensor to perform the sensor resume procedure may include the operation at block S21: reducing an initial shutter time of the second imaging sensor to reduce a sensor resume time of the second imaging sensor.

As illustrated in FIG. 7, at block S42, determining, based on the AP request, whether it is necessary to switch the imaging sensor.

In some embodiments, in response to no necessary to switch the imaging sensor, at block S431: calculating the 3A parameters; at block S432: performing switch flow control; at block S433: performing sensor settings; and, at block S434: driving, by the sensor driver, the current imaging sensor to perform image acquisition.

In some embodiments, in response to being necessary to switch to the second imaging sensor, the process may proceed to block S441 to perform 2A synchronization, for example, synchronizing the current shutter time and the ISO value of the first imaging sensor to the second imaging sensor. At block S442, scene detection may be performed. The scene detection process may include, for example, detecting the lighting conditions of the current shooting scene, such as a brightness of the shooting scene and/or whether it is a flicker scene. At block S443, recalculating the shutter time of the second imaging sensor. At block S444, performing switch flow control for the second imaging sensor. At block S445, performing sensor settings for the second imaging sensor. At block S446, the sensor driver may drive the second imaging sensor to perform the sensor resume procedure.

In some embodiments, using a current shutter time of the first imaging sensor as a reference for the initial shutter time of the second imaging sensor; and, reducing, based on the reference, the initial shutter time. In other words, setting the current shutter time of the first imaging sensor as an initial value of the initial shutter time, and reducing the initial value.

As illustrated in FIG. 8, FIG. 8 is a schematic flow diagram for determining the shutter time of the second imaging sensor in the sensor resume procedure.

In some embodiments, the initial shutter time of the second imaging sensor may be reduced based on the lighting conditions of the shooting scene. As illustrated in FIG. 8, the operation at block S51: determining whether the current shooting scene is a scene with insufficient light. Specifically, if the brightness of the shooting scene is less than a brightness threshold, or if the current shutter time of the first imaging sensor is greater than a shutter threshold time, the current shooting scene may be determined to be a scene with insufficient light. The brightness threshold may be measured in Lux. The brightness threshold may be, for example, 15 lux, 13 lux, or 10 lux, etc. The brightness threshold may be determined according to specific conditions such as the performance of the imaging device 100 or imaging sensor, which is not limited herein. The shutter threshold time may be, for example, 33 ms, 30 ms, etc. Generally speaking, a shutter time greater than the shutter time threshold may indicate that, the current shooting scene has insufficient light. The brightness of the shooting scene may be collected by, for example, the first imaging sensor or other brightness detection devices of the imaging device, which is not limited herein.

In some embodiments, as illustrated at block S52 of FIG. 8, in response to the current shooting scene being a scene with insufficient light, the current shutter time of the first imaging sensor may be used as the shutter time of the second imaging sensor during the sensor resume procedure.

In some embodiments, the initial shutter time of the second imaging sensor may be reduced when the brightness of the shooting scene is greater than the brightness threshold, or the current shutter time of the first imaging sensor is less than the shutter time threshold. Generally speaking, if the brightness of the shooting scene is greater than the brightness threshold, or the current shutter time of the first imaging sensor is less than the shutter time threshold, it may indicate that the current shooting scene is a scene with sufficient light, and the initial shutter time adopted by the second imaging sensor in the sensor resume procedure may be reduced, so as to reduce a total time occupied by the sensor resume procedure of the second imaging sensor.

In some embodiments, as illustrated at block S53 of FIG. 8, in response to the current shooting scene not being the scene with insufficient light, determining whether the current shooting scene is a flicker scene. The flicker scene may refer to a case where light intensity or color in the environment changes rapidly with time, or flickers exists. The flicker scene may be such as scenes using flickering artificial light sources, scenes where the shooting object includes flickering objects (for example, the shooting subjects are such as electronic screens, street lamps, traffic lights, etc.), moving shooting scenes with light and dark changes, or other scenes. Taking the lighting source powered by public power grid (mains electricity or city power) as an example, the flicker frequency thereof may generally be 50 Hz or 60 Hz. A flickering scene has a flicker period. When the flicker frequency is f, the corresponding flicker period is 1 s/f. When the flicker frequency is 50 Hz, the corresponding flicker period is 20 ms. When the flicker frequency is 60 Hz, the corresponding flicker period is approximately 16.7 ms.

In some embodiments, the initial shutter time of the second imaging sensor in the sensor resume procedure may be reduced, the initial sensor gain value of the second imaging sensor in the sensor resume procedure may be at the same time increased, so as to ensure that, the sensor resume time of the second imaging sensor may be less than or equal to a time length of one frame, and a changing rate of an exposure of the second imaging sensor relative to current exposure of the first imaging sensor may be less than a preset ratio. The preset ratio may be for example 2%, 5%, 10%, or the like.

In some embodiments, as illustrated at block S54 of FIG. 8, in response to the shooting scene being the flicker scene, reducing the initial shutter time of the second imaging sensor to a fixed value. The fixed value may be, for example, an integer multiple of half the flicker period of the flicker scene, such as 1 time, 2 times, etc., of half of the flicker period. For example, the fixed value may be half of the flicker period of the flicker scene. For instance, when the flicker frequency is 50 Hz corresponding to the flicker period of 20 ms, the initial shutter time may be reduced to an integer multiple of half the flicker period, i.e., 10 ms, 20 ms, etc. When the flicker frequency is 60 Hz corresponding to a flicker period of approximately 16.7 ms, the initial shutter time may be reduced to an integer multiple of half the flicker period, i.e., 8.85 ms, 16.7 ms, etc. The adjusted initial shutter time should generally not exceed 30 ms.

With reference to Table 1 and Table 2 below, Table 1 exemplarily illustrates initial 2A parameters in three different scenes, namely Scene 1, Scene 2, and Scene 3. The 2A parameters may be, for example, the 2A parameters synchronized from the first imaging sensor as described above. Specifically, the 2A parameters may include the first shutter time and the first ISO value. Table 2 illustrates the setting values of the initial shutter time and initial ISO value of the second imaging sensor in the sensor resume procedure when the shooting scene is a flicker scene with a flicker frequency of 50 Hz. As illustrated in Table 2, the initial shutter time may be set to a fixed value. In this case, the initial shutter time may specifically be 10 ms, which is half of the flicker period.

In some embodiments, the initial ISO value may be set based on the initial shutter time, so as to ensure that the exposure remains unchanged. The exposure may be roughly expressed as a product of the shutter time and the ISO value. By way of example and not limitation, a calculation formula for the initial ISO value may be:

$$Formula ( 1 )$$

$$initial ISO value = first exposure / initial shutter time = ( first shutter time \times first ISO value ) / initial shutter time$$

The initial ISO values in Table 2 are calculated according to the aforementioned Formula (1). Taking Scene 1 as an example, it may be seen from Table 1 that, the first shutter time is 30 ms, and the first ISO value is 300. It may be seen from Table 2 that the initial shutter time is fixed at 10 ms. Substituting these values into the Formula (1), the initial ISO value in Scene 1 is calculated as 300. The same logic may apply to the Scene 2 and the Scene 3, which would not be repeated in the present disclosure.

TABLE 1

| | first shutter | |
|---|---|---|
| scene index | time (ms) | first ISO value |
| 1 | 30 | 300 |
| 2 | 20 | 300 |
| 3 | 10 | 100 |

TABLE 2

| | initial shutter | |
|---|---|---|
| scene index | time (ms) | initial ISO value |
| 1 | 10 | 900 |
| 2 | 10 | 600 |
| 3 | 10 | 100 |

In some embodiments, in response to the shooting scene being a non-flicker scene, the initial sensor gain (also referred to as the ISO) value may be increased, and the initial shutter time may be reduced. Specifically, the initial sensor gain value may be increased to a maximum gain value allowed by the second imaging sensor. The reduction multiple of the initial shutter time may be between 0.9 and 1.1 times the increase multiple of the initial sensor gain value.

In some embodiments, as illustrated at block S55 of FIG. 8, in a case where the shooting scene is a non-flicker scene, the ISO value of the second imaging sensor may be increased to a preset value. By way of example only and not limitation, the preset value may be 6400, 10000, 12000, etc., which is not limited herein.

In some embodiments, the ISO value of the second imaging sensor may be set to a maximum threshold. The maximum threshold may be a maximum value that the second imaging sensor may support during normal operation. Optionally, the maximum threshold may also be a maximum value set by the user or the imaging device, etc.

In some embodiments, in response to the shooting scene being the non-flicker light, increasing the initial sensor gain value to a maximum gain value allowed by the second imaging sensor. A reduction multiple of the initial shutter time may be between 0.9-1.1 times the increase multiple of the initial sensor gain value. In this way, the change of the brightness of the image obtained by the second imaging sensor during the sensor resume procedure may not be too much.

Please reference to the above Table 1 and the flowing Table 3. Table 3 illustrates the setting values of the initial shutter time and initial ISO value of the second imaging sensor in the sensor resume procedure when the shooting scene is the non-flicker scene. Specifically, the first ISO value may be increased to a preset value as the initial ISO value. The preset value is exemplarily illustrated as 6400 in Table 3. Further, the initial shutter time may be set based on the initial ISO value, so as to ensure that the exposure remains unchanged. By way of example and not limitation, the calculation formula for the initial shutter time may be:

$$Formula ( 2 )$$

$$initial shutter time = first exposure / initial ISO value = ( first shutter time \times first ISO value ) / initial ISO value$$

The initial shutter times in Table 3 are calculated according to Formula (2). Taking Scene 1 as an example, it may be seen from Table 1 that, the first shutter time is 30 ms and the first ISO value is 300. It may be seen from Table 3 that the initial ISO value takes the maximum value of 6400. Substituting these values into Formula (2), the initial shutter time in Scene 1 is thus 1.41 ms. The same logic applies to Scene 2 and Scene 3, which will not be repeated in the present disclosure.

In some embodiments, the initial shutter time of the second imaging sensor may be reduced, so that the sensor resume time of the second imaging sensor may be less than or equal to the time duration of one frame. Specifically, the initial ISO value may be set to a specific value, which may enable the initial shutter time calculated according to Formula (2) to be less than or equal to the time duration of one frame.

TABLE 3

| | initial shutter | initial ISO value (set |
|---|---|---|
| scene index | time (ms) | as a maximum value) |
| 1 | 1.41 | 6400 |
| 2 | 0.94 | 6400 |
| 3 | 0.16 | 6400 |

As illustrated in FIG. 8, further, at block S56: the new ISO value and the new shutter time may be applied to the second imaging sensor; at block S57: a software control flow for the second imaging sensor may be performed; at block S58: the second imaging sensor may be set; and, at block S59: the sensor driver may drive the second imaging sensor to perform the sensor resume procedure using the new ISO value and the new shutter time.

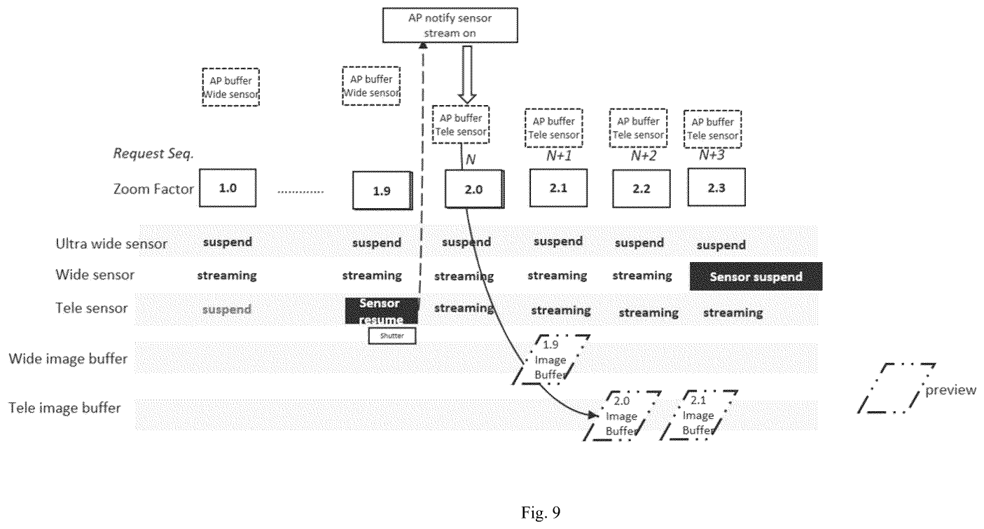

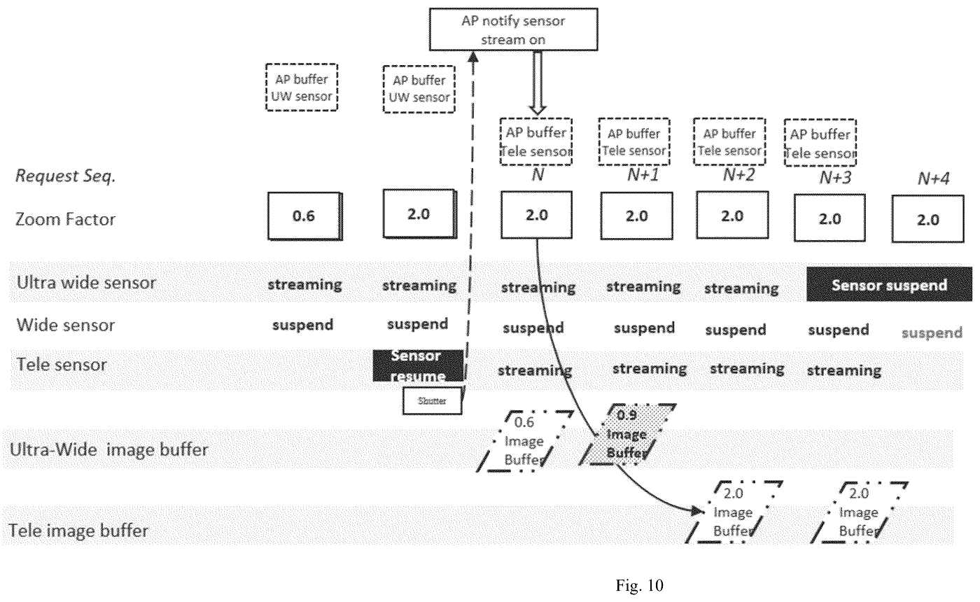

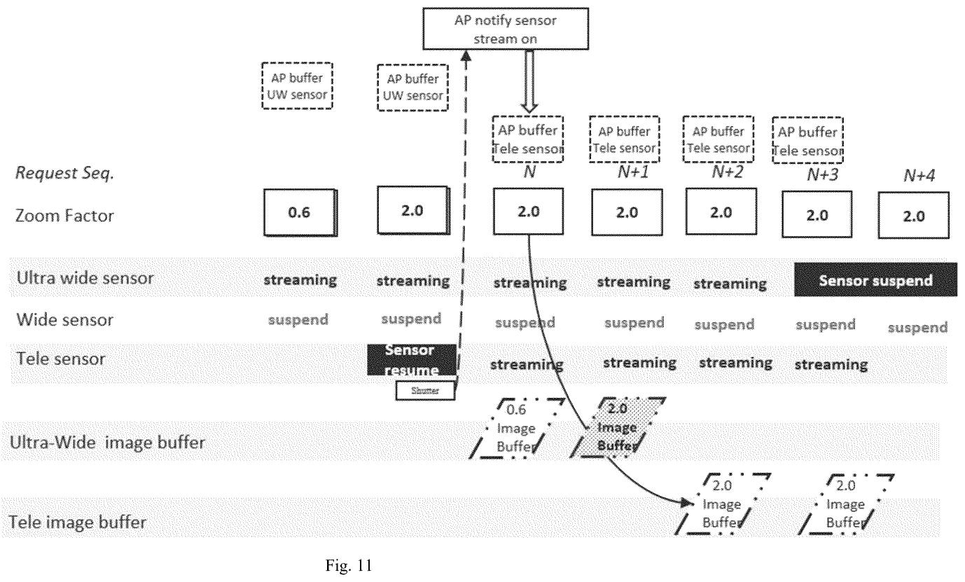

The technical effects of reducing the initial shutter time of the second imaging sensor in the present disclosure may be discussed below with reference to FIGS. 9-11. FIG. 9 is a schematic timing diagram of a procedure where a user switches the imaging sensors through dynamic adjustment according to some embodiments of the present disclosure, FIG. 10 is a schematic timing diagram of a procedure where a user switches the imaging sensors through direct designation according to some embodiments of the present disclosure, and FIG. 11 is a schematic timing diagram of a procedure where a user switches the imaging sensors through direct designation according to another embodiments of the present disclosure.

As illustrated in FIG. 9, the imaging device 100 may include three imaging sensors: the ultra-wide sensor, the wide sensor, and the telephoto sensor. In the beginning, the zoom factor is 1.0×, the wide sensor is in an operation (streaming) state, and each of the ultra-wide sensor and the telephoto sensor are in a suspending state. Here, the wide sensor, i.e., the first imaging sensor, may collect the image data, and the application processor may buffer the image data collected by the wide sensor.

Subsequently, the user may dynamically adjust the zoom factor by sliding or dragging a zoom bar. When the user increases the zoom factor to 1.9×, the zoom factor may enter the third sensor switching interval R3 of the wide sensor as illustrated in FIG. 3, thereby triggering the sensor resume procedure of the telephoto sensor (i.e., the second imaging sensor or the target imaging sensor). As illustrated in FIG. 9, the embodiments of the present disclosure may reduce the initial shutter time of the telephoto sensor in the sensor resume procedure, so that the time duration of the sensor resume procedure may be less than one frame. Those skilled in the art would understand that, during the sensor resume procedure, the data collected by the second imaging sensor may not generate a specific preview image. After the sensor resume procedure of the second imaging sensor is completed, the application processor may notify the imaging device 100 that the second imaging sensor enters the data streaming state, and the application processor may begin to buffer the image data collected by the second imaging sensor in subsequent frames for preview.

There may be a delay of several frames between the time when the image data being buffered and the time when the image data being displayed on the preview interface. As illustrated in FIG. 9, by way of example only, there may be a two-frame delay from when the image captured by the second imaging sensor is buffered to when it is previewed to the end user. The preview images in FIG. 9 are illustrated by dashed-edged parallelogram boxes. Therefore, it may happen that, although the currently buffered image is captured by the second imaging sensor, the previewed image still comes from the image data previously captured by the first imaging sensor.

In some embodiments, within one or more frames after the second imaging sensor enters the data streaming state, the first imaging sensor may continue to operate, so as to prevent the end user from changing the direction of zoom factor adjustment. At this time, the imaging device 100 may be in a dual-camera-operating interval, and the wide sensor and the telephoto sensor may operate simultaneously. At this time, if the end user changes the direction of zoom factor adjustment, the wide sensor may quickly output image data. If the end user does not change the direction of zoom factor adjustment, the first imaging sensor may enter a suspended state later, so as to save power.

In some embodiments, after the sensor resume procedure, capturing image frames by the second imaging sensor and buffing the captured image frames for future preview. Turning off the first imaging sensor within at most three frames after the current cut zoom factor dynamically adjusted to has exceeded the first zoom factor range.

In the embodiment illustrated in FIG. 9, by reducing the initial shutter time of the second imaging sensor in the sensor resume procedure, the second imaging sensor may quickly complete the sensor resume procedure and enter the data streaming state. In this way, the present disclosure may obtain the correct sensor output image more timely at the corresponding zoom ratio. In this way, optimization of response speed may be achieved, the dual-camera operation interval may be shortened, and the problems of power consumption and heating of the imaging device 100 may be further reduced.

In the embodiment of FIG. 9, by way of example and not limitation, the wide sensor may maintain a stable output of 30 frames per second (fps) to ensure smooth and continuous video shooting. When the telephoto sensor is activated, the telephoto camera is framesynced with the wide sensor (also referred to as the main eye) to achieve seamless transition and maintain the integrity of the captured material. The telephoto sensor may be designed to capture detailed images at long distances, and its first frame output starts synchronously with the wide sensor. This frame synchronization ensures that the two sensors may operate together to provide coherent and synchronized video output.

As illustrated in FIG. 10 and FIG. 11, the imaging device 100 may also include three imaging sensors: the ultra-wide sensor, the wide sensor, and the telephoto sensor. In the beginning, the zoom factor is 0.6×, the ultra-wide sensor is in an operation (streaming) state, and the wide sensor and the telephoto sensor are in the suspending state. Here, the ultra-wide sensor, i.e., the first imaging sensor, may collect the image data at a zoom factor of 0.6×, and the application processor may buffer the image data collected by the ultra-wide sensor.

Subsequently, the end user may set a new target zoom factor by means of direct designation. As illustrated in FIG. 10, when the end user increases the zoom factor to 2.0×, the zoom factor enters the focal length range of the telephoto sensor, and the imaging device 100 may trigger the sensor resume procedure of the telephoto sensor (i.e., the second imaging sensor or the target imaging sensor). As illustrated in FIG. 10, the embodiments of the present disclosure may reduce the initial shutter time of the telephoto sensor in the sensor resume procedure, so that the time duration of the sensor resume procedure is less than one frame. Those skilled in the art should understand that, during the sensor resume procedure, the data collected by the second imaging sensor does not generate a specific preview image. After the sensor resume procedure of the second imaging sensor is completed, the application processor may notify the imaging device 100 that the second imaging sensor enters the data streaming state, and the application processor may start to buffer the image data collected by the second imaging sensor in subsequent frames for preview.

There may be a delay of several frames between the time when the image data being buffered and the time when the image data being displayed on the preview interface. As illustrated in FIG. 10, by way of example only, there may be a two-frame delay from when the image captured by the second imaging sensor is buffered to when this image is previewed to the user. Therefore, it may happen that although the currently buffered image is captured by the second imaging sensor, the previewed image still comes from the image data previously captured by the first imaging sensor.

In some embodiments, after the sensor resume procedure, updating, based on an image captured by the second imaging sensor during the sensor resume procedure, a shutter time and a sensor gain value of the second imaging sensor; turning off the first imaging sensor, and capturing, through the second imaging sensor and based on the updated shutter time and sensor gain value, a first frame after the sensor resume procedure; and buffering the first frame, and displaying a buffered image frame on a preview interface of the imaging device, wherein the buffered image frame is captured by the first imaging sensor before the sensor resume procedure of the second imaging sensor is completed. Optionally, the second imaging sensor may capture a second frame after the sensor resume procedure. The second frame may be buffered. The buffered image frame previously captured by the first imaging sensor, which has subject to a crop zoom process, may be displayed on the preview interface.

In some embodiments, within one or more frames after the second imaging sensor enters the data streaming state, the first imaging sensor may continue to be in the data streaming state. At this time, the imaging device 100 is in a dual-camera-operation interval, and the ultra-wide sensor and the telephoto sensor may operate simultaneously. The first imaging sensor may continue to capture the first image at a zoom factor before the user switches the zoom factor. The imaging device 100 may display the buffered image frame after performing a crop zoom process on the preview interface.

In some embodiments, as illustrated in FIG. 10, a zoom factor of the crop zoom process may range from an original zoom factor to the target zoom factor. For example, the zoom factor of the crop zoom process may be 0.9× in FIG. 10. The original zoom factor is the zoom factor of the first imaging sensor immediately before the direct designation (for example, point cut) zoom operation. In this case, due to the crop magnification of the crop zoom process not reaching the target zoom factor selected by the end user (which is 2.0× here), there may be a sense of stuttering or jumps in the preview image.

In some embodiments, as illustrated in FIG. 11, the zoom factor corresponding to the crop zoom process is the target zoom factor selected by the end user in the direct designation zoom operation (here the point cut zoom operation), i.e., 2.0×. In this case, the preview image may become blurrier due to the excessive magnification factor of the crop zoom process.

In the embodiments of FIG. 10 and FIG. 11, by reducing the initial shutter time of the second imaging sensor in the sensor resume procedure, the second imaging sensor may quickly complete the sensor resume procedure and enter the data streaming state. In this way, the present disclosure may obtain the correct sensor output image more timely at the corresponding zoom ratio, reduce the number of frames with stuttering or blur, and achieve optimization of response speed. At the same time, the dual-camera-operation interval may also be shortened, further reducing the problems of power consumption and heating of the imaging device.

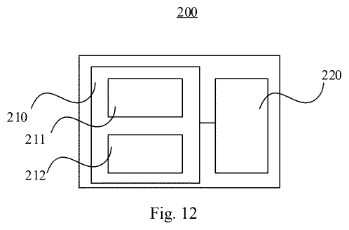

As illustrated in FIG. 12, FIG. 12 is a schematic structural diagram of an imaging device 200 according to some embodiments of the present disclosure. The present disclosure may also provide an imaging device 200. The imaging device 200 may include a plurality of imaging sensors 210 and an application processor 220. The plurality of imaging sensors 210 may include a first imaging sensor 211 and a second imaging sensor 212. In some embodiments, the plurality of imaging sensors 210 may at least include the ultra-wide sensor, the wide sensor, and the telephoto sensor. The application processor 220 may store executable code. The application processor 220 may be configured to execute the executable code to perform the method for controlling the imaging device 200 described above with reference to FIGS. 1-11.

If the integrated units in the above-mentioned other embodiments are implemented in the form of software functional units and sold or used as independent product, then they could be stored in a computer-readable storage medium. Based on such kind of understanding, the technical solution of the present disclosure essentially or a part contributing to the prior art or part or all of the technical solution may be embodied in the form of software products. The computer software products may be stored in one storage medium. The computer software products may include some instructions for causing a computer device (which may be a personal computer, a server or a network device, etc.) or a processor to implement all or part of the operations of the methods described in various embodiments of the present disclosure. The afore-mentioned storage medium may include: U disk, mobile hard disk drive, read-only memory (ROM), random access memory (RAM), magnetic disk or CD-ROM and other media that can store program codes.

The above are only implementations of the present disclosure, and do not limit the patent scope of the present disclosure. Any equivalent changes to the structure or processes made by the description and drawings of this application or directly or indirectly used in other related technical field are included in the protection scope of this application.

What is claimed is:

1. A method for controlling an imaging device, the imaging device comprising a plurality of imaging sensors, the plurality of imaging sensors comprising a first imaging sensor and a second imaging sensor, wherein the control method comprises:
determining, when the first imaging sensor is in operation, whether it is necessary to switch to the second imaging sensor;
instructing, in response to being necessary to switch to the second imaging sensor, the second imaging sensor to perform a sensor resume procedure;
wherein the instructing the second imaging sensor to perform the sensor resume procedure comprises:
reducing an initial shutter time of the second imaging sensor to reduce a sensor resume time of the second imaging sensor.

2. The method as claimed in claim 1, wherein
the first imaging sensor comprises a first zoom factor range, and the second imaging sensor comprises a second zoom factor range different from the first zoom factor range, the first zoom factor range comprises a sensor switching interval, and the sensor switching interval is a preset interval in the first zoom factor range adjacent to the second zoom factor range;
the determining whether it is necessary to switch to the second imaging sensor comprises:
in a case where an end user performs a dynamic adjustment zoom operation, in response to a zoom direction of the zoom operation being from the first zoom factor range to the second zoom factor range and a current zoom factor being within the sensor switching interval, determining that it is necessary to switch to the second imaging sensor.

3. The method as claimed in claim 1, wherein
the first imaging sensor comprises a first zoom factor range, and the second imaging sensor comprises a second zoom factor range different from the first zoom factor range;
the determining whether it is necessary to switch to the second imaging sensor comprises:
in a case where an end user performs a direct designation zoom operation, in response to a zoom factor selected by the end user being within the second zoom factor range, determining that it is necessary to switch to the second imaging sensor.

4. The method as claimed in claim 1, wherein
the instructing the second imaging sensor to perform the sensor resume procedure comprises:
using a current shutter time of the first imaging sensor as a reference for an initial shutter time of the second imaging sensor; and
reducing, based on the reference, the initial shutter time.

5. The method as claimed in claim 1, wherein
the reducing the initial shutter time of the second imaging sensor to reduce the sensor resume time of the second imaging sensor comprises:
reducing the initial shutter time of the second imaging sensor, such that the sensor resume time of the second imaging sensor is less than or equal to a time length of one frame.

6. The method as claimed in claim 5, wherein
the reducing the initial shutter time of the second imaging sensor to reduce the sensor resume time of the second imaging sensor comprises:
reducing the initial shutter time of the second imaging sensor, and increasing the initial sensor gain value of the second imaging sensor in the sensor resume procedure, such that the sensor resume time of the second imaging sensor is less than or equal to a time length of one frame, and a changing rate of an exposure of the second imaging sensor relative to current exposure of the first imaging sensor is less than a preset ratio.

7. The method as claimed in claim 1, wherein
the reducing the initial shutter time of the second imaging sensor to reduce the sensor resume time of the second imaging sensor comprises:
reducing, based on a lighting condition of a shooting scene, the initial shutter time of the second imaging sensor.

8. The method as claimed in claim 7, wherein
the reducing, based on the lighting condition of the shooting scene, the initial shutter time of the second imaging sensor comprises:
in a case where a brightness of the shooting scene is greater than a brightness threshold, or in a case where a current shutter time of the first imaging sensor is less than a shutter time threshold, reducing the initial shutter time of the second imaging sensor.

9. The method as claimed in claim 8, wherein
the shutter time threshold is 33 milliseconds.

10. The method as claimed in claim 8, wherein
the in a case where the brightness of the shooting scene is greater than the brightness threshold, or the current shutter time of the first imaging sensor is less than the shutter time threshold, reducing the initial shutter time of the second imaging sensor comprises:
in response to the shooting scene being a flicker scene, reducing the initial shutter time of the second imaging sensor to an integer multiple of half of a flicker period of the flicker scene; and/or
in response to the shooting scene being a non-flicker light, increasing an initial sensor gain value and reducing the initial shutter time.

11. The method as claimed in claim 10, wherein
the in response to the shooting scene being the non-flicker light, increasing the initial sensor gain value and reducing the initial shutter time comprises:
increasing the initial sensor gain value to a maximum gain value allowed by the second imaging sensor during normal operation;
wherein a reduction multiple of the initial shutter time is between 0.9-1.1 times the increase multiple of the initial sensor gain value.

12. The method as claimed in claim 10, wherein
the increasing the initial sensor gain value to the maximum gain value allowed by the second imaging sensor during the normal operation comprises:
increasing the initial sensor gain value to 6400.

13. The method as claimed in claim 8, wherein
the in a case where the brightness of the shooting scene is greater than the brightness threshold, or the current shutter time of the first imaging sensor is less than the shutter time threshold, reducing the initial shutter time of the second imaging sensor comprises:
in response to the shooting scene being the flicker scene, setting the initial shutter time to half of a flicker period of the flicker scene.

14. The method as claimed in claim 3, further comprising:
after the sensor resume procedure, updating, based on an image captured by the second imaging sensor during the sensor resume procedure, a shutter time and a sensor gain value of the second imaging sensor;
turning off the first imaging sensor, and capturing, through the second imaging sensor and based on the updated shutter time and sensor gain value, a first frame after the sensor resume procedure; and
buffering the first frame, and displaying a buffered image frame on a preview interface of the imaging device, wherein the buffered image frame is captured by the first imaging sensor before the sensor resume procedure of the second imaging sensor is completed.

15. The method as claimed in claim 14, further comprising:
capturing, by the second imaging sensor, a second frame after the sensor resume procedure; and
buffering the second frame, and displaying the buffered image frame, which has subject to a crop zoom process, on the preview interface.

16. The method as claimed in claim 15, wherein
a zoom factor of the crop zoom process is a target zoom factor selected by the end user during the point cut zoom operation; or
the zoom factor of the crop zoom process ranges from an original zoom factor to the target zoom factor, wherein the original zoom factor is a zoom factor of the first imaging sensor immediately before the point cut zoom operation.

17. The method as claimed in claim 2, further comprising:
after the sensor resume procedure, capturing image frames by the second imaging sensor and buffing the captured image frames for future preview; and
turning off the first imaging sensor within at most three frames after the current sliding cut zoom factor exceeds the first zoom factor range.

18. An imaging device, comprising a plurality of imaging sensors and an application processor, the plurality of imaging sensors comprising a first imaging sensor and a second imaging sensor, the application processor storing executable code, the application processor configured to execute the executable code to perform a method for controlling the imaging device, wherein the method comprises:
determining, when the first imaging sensor is in operation, whether it is necessary to switch to the second imaging sensor;
instructing, in response to being necessary to switch to the second imaging sensor, the second imaging sensor to perform a sensor resume procedure;
wherein the instructing the second imaging sensor to perform the sensor resume procedure comprises:
reducing an initial shutter time of the second imaging sensor to reduce a sensor resume time of the second imaging sensor.

19. The imaging device as claimed in claim 18, wherein
the first imaging sensor comprises a first zoom factor range, and the second imaging sensor comprises a second zoom factor range different from the first zoom factor range;
the determining whether it is necessary to switch to the second imaging sensor comprises:
in a case where an end user performs a dynamic adjustment zoom operation, and the first zoom factor range comprises a sensor switching interval, the sensor switching interval is a preset interval in the first zoom factor range adjacent to the second zoom factor range, in response to a zoom direction of the zoom operation being from the first zoom factor range to the second zoom factor range and a current zoom factor being within the sensor switching interval, determining that it is necessary to switch to the second imaging sensor;
in a case where the end user performs a direct designation zoom operation, in response to the zoom factor selected by the end user being within the second zoom factor range, determining that it is necessary to switch to the second imaging sensor; or
in a case where a distance from a to-be-shot object to the imaging device is less than a minimum focusing distance of the first imaging sensor and greater than a minimum focusing distance of the second imaging sensor, determining that it is necessary to switch to the second imaging sensor.

20. The imaging device as claimed in claim 18, wherein
the reducing the initial shutter time of the second imaging sensor to reduce the sensor resume time of the second imaging sensor comprises:
reducing the initial shutter time of the second imaging sensor, such that the sensor resume time of the second imaging sensor is less than or equal to a time length of one frame.
